(19) United States
(12) Patent Application Publication
(10) Pub. No.: US 2018/0013193 A1
(43) Pub. Date: Jan. 11, 2018

(54) CHANNEL RECONFIGURABLE MILLIMETER-WAVE RADIO FREQUENCY SYSTEM BY FREQUENCY-AGILE TRANSCEIVERS AND DUAL ANTENNA APERTURES

(71) Applicant: Google Inc., Mountain View, CA (US)

(72) Inventors: Eric Olsen, Mountain View, CA (US); Nicholas Ng, Mountain View, CA (US); Jing Liang, Mountain View, CA (US); Dedi Haziza, Mountain View, CA (US); Erik Stauffer, Mountain View, CA (US)

(21) Appl. No.: 15/203,494

(22) Filed: Jul. 6, 2016

(51) Int. Cl. H01Q 1/28; H01Q 3/02; H01Q 1/48

(52) U.S. Cl. CPC H01Q 1/288; H01Q 1/48; H01Q 3/02

(57) ABSTRACT

A mobile platform includes an antenna adapted to simultaneously transmit on a first channel and receive on a second channel, and to dynamically switch communication channels as needed. For example, as the mobile platform changes position, orientation, etc., the configuration of the antenna may be updated to transmit on the second channel and receive on the first channel. Accordingly, despite changes in position or orientation, the mobile platform may maintain communication with other mobile platforms, ground controllers, user equipment, etc.

### BACKGROUND

On some high-throughput high-mobility communication platforms, such as satellites, drones, balloons, etc., network payloads need to provide wireless voice/data links directly to user equipments and also need to build up and maintain reliable and versatile inter-platform and gateway back-haul links. Such inter-platform and gateway backhaul links stream the user voice/data to the backbones of the telecommunication networks and/or the Internet, over long distances.

Millimeter-wave (mmWave) radio system may be used for the back-haul communication links. MMwave radio systems are typically reliable, cost effective, and have high throughput capacities and low latency. However, traditional mmWave networks, such as terrestrial mmWave Point-To-Point (PTP), Point-To-Multipoint (PTM), or mesh backhaul networks have fixed geographical positions, relative displacements between nodes, etc. In contrast, high-mobility platforms are subject to change position, relative displacements, headings, etc. which may affect system configuration, such as the configuration of inter-platform communication links. Accordingly, traditional fixed Frequency Division Duplexing (FDD) mmWave communication systems cannot be directly applied to these high-mobility communication platforms. The FDD mmWave systems rely on the fixed-frequency diplexer, to provide two frequency channels, one for Transmitting (Tx) and one for Receiving (Rx). The diplexer is required to provide isolation between Tx and Rx channels, for suppressing Tx signal power leakage to Rx circuits, and avoiding damaging or saturating the sensitive Rx electronics. Also, the diplexer is required for rejecting Tx spectrum-regrowth noise contents leaking to Rx frequency-band, to avoid degrading Rx Signal-To-Noise Ratio (SNR). The mmWave diplexers are generally implemented by high-tolerance mechanical fabrication technologies, such as milling, molding, plating, etc., and hence have fixed pass-bands and rejection-bands.

Time Division Duplex (TDD) mmWave communication systems for short-range operation also cannot be directly applied for these high-mobility inter-platform links. These high-mobility platforms are usually deployed to cover large service regions, and have much longer distance/grid-spacing between platforms. Hence, the communication latency introduced by the electromagnetic-wave propagations delays between these platforms, will be linearly scaled with the distance itself. The TDD systems usually require time-sharing a single frequency channel, as well as need multiple Tx/Rx hand-offs for redundant acknowledge data, in to guarantee no packet loss between the links. Hence, the TDD systems introduce additional latency between long-distance-spacing platforms payloads. Long latency not only significantly affects the end user experiences, but also reduces the average aggregate data throughput of these backhaul links.

### BRIEF SUMMARY

A system and method is provided for mmWave communication between mobile platforms, such as unmanned aerial vehicles (UAVs), satellites, buoys, balloons, etc. A mobile platform includes an antenna adapted to simultaneously transmit on a first channel and receive on a second channel, and to dynamically switch communication channels as needed. For example, as the mobile platform changes position, orientation, etc., the configuration of the antenna may be updated to transmit on the second channel and receive on the first channel. Accordingly, despite changes in position or orientation, the mobile platform may maintain communication with other mobile platforms, ground controllers, user equipment, etc.

One aspect of the disclosure provides a multidirectional antenna, including a first antenna aperture, a frequency-tunable wide-band upconverter coupled to the first aperture, the upconverter adapted to transmit millimeter wave radio frequency signals, a second antenna aperture physically spaced from the first aperture, and a frequency-tunable wide-band downconverter coupled to the second antenna, the downconverter adapted to receive millimeter wave radio frequency signals. The upconverter may be configured to transmit on one of a first frequency channel and a second frequency channel, and the downconverter may be configured to receive, concurrently with the transmission by the upconverter, on the second frequency channel if the upconverter is transmitting on the first frequency channel, or on the first frequency if the upconverter is transmitting on the second frequency channel. In some examples, the antenna further includes a first frequency selection submodule coupled between the upconverter and the first aperture, and a second frequency selection submodule coupled between the downconverter and the second aperture, each frequency selection submodule comprising a first frequency filter coupled in parallel with a second frequency filter between two single pole double throw switches. Moreover, the antenna may be expanded to a third antenna aperture coupled to a second upconverter, and a fourth antenna aperture coupled to a second downconverter, wherein the third antenna aperture and the fourth antenna aperture are configured to operate on different channels than the first aperture and second aperture.

Another aspect of the disclosure provides a mobile platform, comprising one or more bidirectional antennas. Each bidirectional antenna includes a first antenna aperture, a second antenna aperture, a transmitter coupled to each of the first aperture and the second aperture, the transmitter adapted to select between different frequency channels, a receiver coupled to each of the first aperture and the second aperture, the receiver adapter to select between different frequency channels, and one or more processors in communication with the bidirectional antenna, the one or more processors programmed to configure the one or more bidirectional antennas, such that the transmitter transmits through one of the first aperture or the second aperture on a first frequency channel, and the receiver receives through one of the first aperture or the second aperture on a second frequency channel, the first aperture and the second aperture operating simultaneously in different modes. The platform may further include one or more sensors configured to detect information related to a position of the mobile platform and communicate the detected information to the one or more processors, and a motor for adjusting a pointing direction of the one or more bidirectional antennas. The mobile platform may be, for example, an unmanned aerial vehicle, a satellite, a balloon, or a buoy.

Yet another aspect of the disclosure provides a method for millimeter wave radio frequency communication. According to this method, position information from one or more sensors is received at one or more processors, and a position and direction of a first antenna on a first mobile platform is determined by the one or more processors based on the received information. Further, the one or more processors determine an operation mode for the first antenna based on the determined position and direction, the operation mode indicating a frequency channel on which to transmit signals and a frequency channel on which to simultaneously receive signals, and provide instructions to the first antenna, causing the first antenna to operate in the determined operation mode. In some examples, the method further includes identifying, with the one or more processors, a predetermined zone in which the mobile platform is positioned, wherein determining the operation mode is further based on the identified predetermined zone. In such examples, the one or more processors may reside on the first mobile platform, and provide instructions to the first antenna by sending low level hardware instructions to locally configure the first antenna. In other examples, the method further includes receiving position information from a second antenna on a second mobile platform, determining, with the one or more processors, relative positions between the first antenna and the second antenna, and determining an operation mode of the second antenna, wherein determining the operation mode for the first antenna is further based on the operation mode of the second antenna. In such examples, the one or more processors may be stationed in a centralized ground control unit.

### BRIEF DESCRIPTION OF THE DRAWINGS

FIG. 1 is a schematic diagram of an example system in a first state according to aspects of the disclosure.

FIG. 2 is a schematic diagram of the example system of FIG. 1 in a second state according to aspects of the disclosure.

FIG. 3 is a block diagram of an example computing system according to aspects of the disclosure.

FIG. 4 illustrates example frequency channels used by a bidirectional antenna in a first mode and a second mode, according to aspects of the disclosure.

FIG. 5 illustrates an example mobile platform having antennas operating in different modes according to aspects of the disclosure.

FIG. 6 illustrates the example mobile platform having antennas operating in different modes according to aspects of the disclosure.

FIG. 7 is a block diagram illustrating an example out-of-band frequency matching system according to aspects of the disclosure.

FIG. 8 is a flow diagram illustrating an example method for out-of-band frequency matching according to aspects of the disclosure.

FIG. 9 is a block diagram illustrating an example onboard matching system according to aspects of the disclosure.

FIG. 10 is a flow diagram illustrating an example method for onboard frequency matching according to aspects of the disclosure.

FIG. 11 is a flow diagram illustrating another example method for frequency matching according to aspects of the disclosure.

FIG. 12 is a schematic diagram illustrating an example multidirectional antenna according to aspects of the disclosure.

FIG. 13 is a schematic diagram illustrating another example multidirectional antenna according to aspects of the disclosure.

FIG. 14 is a schematic diagram illustrating communication between the example multidirectional antenna of FIG. 13 and another multidirectional antenna, according to aspects of the disclosure.

FIG. 15 is a schematic diagram illustrating another example multidirectional antenna according to aspects of the disclosure.

FIG. 16 is a schematic diagram illustrating another example multidirectional antenna according to aspects of the disclosure.

### DETAILED DESCRIPTION

The technology relates generally to a millimeter wave (mmWave) radio frequency (RF) system, adapted for use in a high-altitude platform (HAP) for inter-HAP communication. The system includes frequency-agile transceivers and high-isolation multiple antenna apertures. This mmWave RF system, positioned on an individual high-mobility platform, comprises multiple beam-steerable antenna apertures with high isolation between each other, wide-band transmitting power amplifier and receiving low noise amplifier modules, frequency-tunable transmitting up-converters and receiving receivers, generic modems that convert digital ethernet/fiber-optic data to/from analog baseband, as well as optional post-front-end solid-state frequency-channel-selection sub-modules.

The multiple antenna apertures are electromagnetic radiators. The dual/multiple antennas are in planar-form, low-volume, low-mass, and high-efficiency. One of the dual/multiple antennas may be used for the transmitting and one for the receiving, with the same size as a single traditional parabolic antenna. The antenna aperture is able to achieve high-directional gain to the desired beam-angle, which intrinsically increases the spatial isolation between the two antenna apertures. In that case, even though the dual antenna system is designed to provide wide-frequency-bandwidth for covering both transmit and receive bands, they are also highly isolated with each other in spatial domain. The dual antenna aperture implementation allows for controlling transmitting/receiving isolation by physically spacing the antennas with each other, which increases flexibility of system implementation. The dual-antenna-aperture could be expanded to triple or more antenna apertures, which supports throughput-capacities upgrades easily.

The system also implements a wide-band transmitting power amplifier, and receiving low-noise amplifier. These amplifiers are wide-band enough to support two or more adjacent frequency channels. For example, the system may operate at mmWave bands, such as carrier frequency 30˜300 GHz. The operation frequency bands of the system are sub-divided for two sub-bands, with center frequencies labeled as F1, F2, and can be expanded to multiple sub-bands, with center frequencies labeled as F3, F4, . . . , Fn. The amplifiers are designed to support wide-frequency bandwidths including F1, F2. Accordingly, regardless of the carrier-frequencies of the sub-band of the upconverter and downconverter, the amplifier modules and the antenna modules are able to support the operation frequencies.

The system further includes wide-band upconverters and downconverters. The carrier frequencies of the upconverters and downconverters are tunable, and switching from one frequency channel to the other frequency channel may be performed in microseconds. The frequency tuning is implemented by the Phase-Locked-Loop (PLL) and Voltage-Controlled Oscillator (VCO). In operation of the dual-antenna system, for example, according to the upper-level network routing command, the transmitting upconverter at one moving platform will be configured to operate centering at either at F1 or at F2. At the same time, the receiving downconverter on the same platform will be configured to operate at the frequency not currently used by the transmitting upconverter, e.g., either F2 or F1. On the other moving platform, the RF system receiving downconverter will be configured to match the inward frequency channel, at either centering at F1, or at F2. At the same time, the transmitting upconverter will be configured to match the outward frequency channel, at either centering at F2, or at F1.

The frequency matching may be performed in any of a variety of ways. For example, the first platform may send position information to a centralized ground control station. The centralized ground control station may also receive information from other platforms near the first platform. Such position information may indicate, for example, relative positions of antennas on each of the first platform and the other platforms. Based on this information, the centralized ground control may determine a configuration for the network, and send control commands to each of the platforms that require updating. For example, the control commands may be used to reconfigure the antennas, such that an antenna previously configured for transmitting is reconfigured for receiving. According to another example of frequency matching, one or more processors on each platform may detect changes in relative position of the antennas, and locally reconfigure the antennas as needed. According to yet another example, the antennas may attempt transmitting or receiving on a particular channel, and if such attempt is still unsuccessful for a predetermined time period, reconfiguring the antenna and making another attempt.

The system also includes a generic modem and sub-system, which can convert the digital Ethernet or/and fiber-optic data to/from the analog base-band waveform, which is interconnected to the frequency-agile RF transceiver. Since all the dynamic frequency conversion is implemented by the frequency-agile upconverter and downconverter, no specific requirements are needed for the generic modem.

Depending on the transmitting/receiving leakage level, optional frequency-selection sub-modules may be implemented. The frequency-selection sub-modules may include dual solid-state single-pole-double-throw (SPDT) switches, as well as compact planar or SMT frequency filters. These frequency-selection sub-modules are providing the leakage filtering after the receiving low-noise amplifier and/or before the transmitting power amplifier. They are providing the transmitting pre-power-amplifier spectrum regrowth suppression, and receiving post-low-noise-amplifier leakage/interference noise rejection. In some examples, resulting insertion losses may be compensated for by the amplifier module gains.

The system also includes digital or/and analog predistortion techniques, to control transmit adjacent channel power leakage (ACPL). In systems where the operation and/or tuning frequencies are only limited to cover a sub-section of the mmWave bands, both the transmitting and receiving channels need to be assigned within these maximum operation sub-bands. Hence, the high-throughput wide-modulated channels on the transmitting side could potentially generate non-neglectable spectrum-regrowth, leaking to the adjacent spectrum, which the receiving channel is assigned to. For example, without digital predistortion, the F1 transmitting channel is generating about −20˜−25 dBc adjacent channel leakage to the spectrum F2, where the receiving circuitry is assigned, without filtering. In that case, in order to reduce the self-interference from the transmitting waveform to the weak receiving signals, besides the intrinsic spatial isolation from the multiple antenna system, a certain digital or/and analog predistortion has to implement, in order to bring down the spectrum-regrowth, and self Tx/Rx interference.

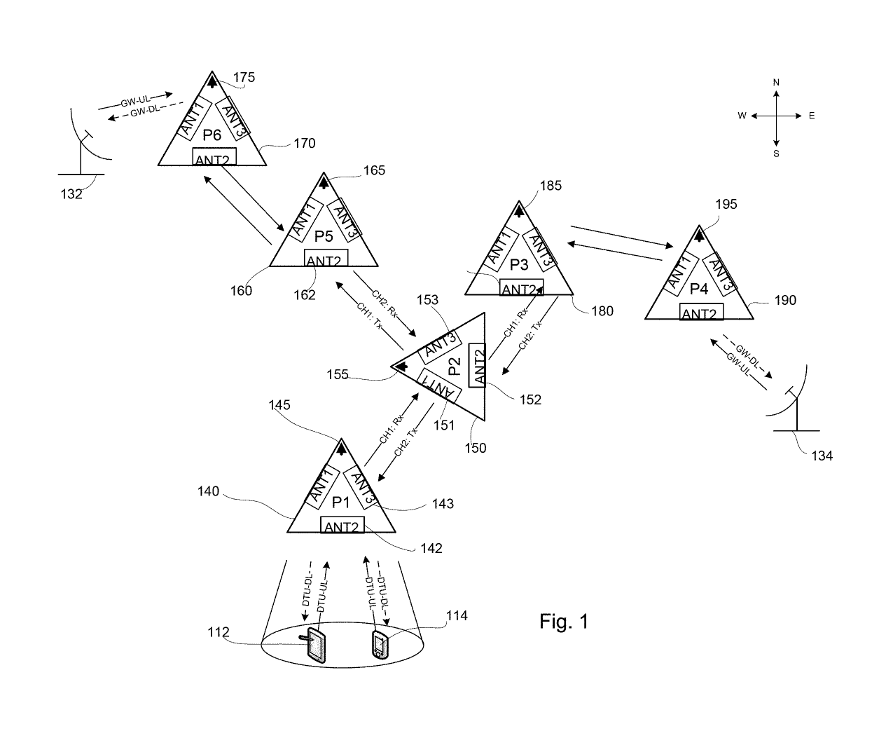

FIG. 1 illustrates a system 100, including a plurality of platforms 140-190, labeled as P1-P6. Each platform 140-190 includes one or more inter-platform links (IPLs). For example, platform P2 includes antennas 151-153, labeled as ANT1-ANT3. These antennas are adapted for communication with neighboring platforms and/or other network components, such as user equipment 112, 114 and ground terminals 132, 134.

The user equipment 112, 114 may be any type of computing device capable of wirelessly communicating with a network. For example, the user equipment 112, 114 may include cellular phones, smart phones, tablets, gaming devices, music players, laptops, etc. In some examples, the user equipment 112, 114 may communicate directly with the platforms. For example, each user equipment 112, 114 may receive data from antenna 142 via a direct-to-user (DTU) downlink (DL), and may transmit data to the antenna 142 via a DTU uplink (UL).

Ground terminals 132, 134 may be, for example, controllers, gateways to other networks, such as wired networks, or any other type of transceivers. The ground terminals 132, 134 may communicate with the platforms via via gateway uplinks (GW-UL) and gateway downlinks (GW-DL). According to some examples, the ground terminals 132, 134 may send instructions used to configure the antennas of the platforms to send or receive on a specified frequency channel.

The platforms 140-190 may be any type of mobile objects, such as UAVs, satellites, buoys, etc. Movement of the platforms 140-190 may be controlled, such as by preprogrammed travel path instructions or by commands from a ground controller. As shown in FIG. 1, each platform 140-190 has its own orientation, indicated by arrows 145-195. One example of platform movement includes circling in an orbit around a station for station keeping. In other examples, movement of the platform may be uncontrolled, such as movements caused by gusts of wind or other environmental factors.

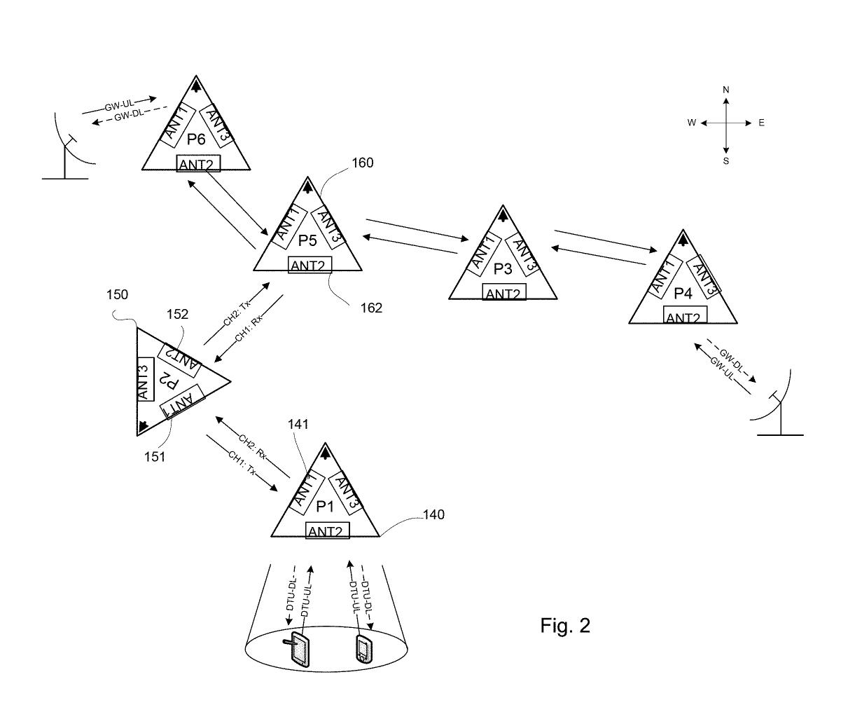

As shown, platform 150 is heading west, while neighboring platforms 145, 165, 185 are each heading north. In the positions shown, antenna 151 of the platform 150 is positioned closest to antenna 143 of the platform 140, while antenna 152 is positioned closest antenna 182 of platform 180, and antenna 153 is positioned closest to antenna 162 of platform 160. In this configuration, antenna 151 receives on a first channel and transmits on a second, antenna 152 receives on the first channel and transmits on the second, and antenna 153 transmits on the first channel and receives on the second. However, if the platform 150 rotates or otherwise changes position, for example, the relative positions of the antennas 151-153 of the platform 150 will change with respect to the antennas 143, 182, 162 of the neighboring platforms 140, 180, 160. An example of such updated positions is shown in FIG. 2.

As seen in FIG. 2, the platform 150 is headed southwest, as if it is moving in an orbit. As such, the first antenna 151 is no longer closest in proximity to the antenna 143 of the platform 140, but rather has a direct line of sight with antenna 141 of the platform 140. Depending on, for example, the configuration of the antenna 141, the antenna 151 may need to be reconfigured. Thus, as shown, while the antenna 151 previously received on the first channel and transmitted on the second channel, it is reconfigured in FIG. 2 to transmit on the first channel and receive on the second channel. Similarly, the configurations of the antennas 152, 153 may change. For example, in the updated position, the antenna 152 communicates with the antenna 162 of the platform 160, and the antenna 153 is left open for communication. One of the antenna 162 and the antenna 152 may need to be reconfigured to establish such communication.

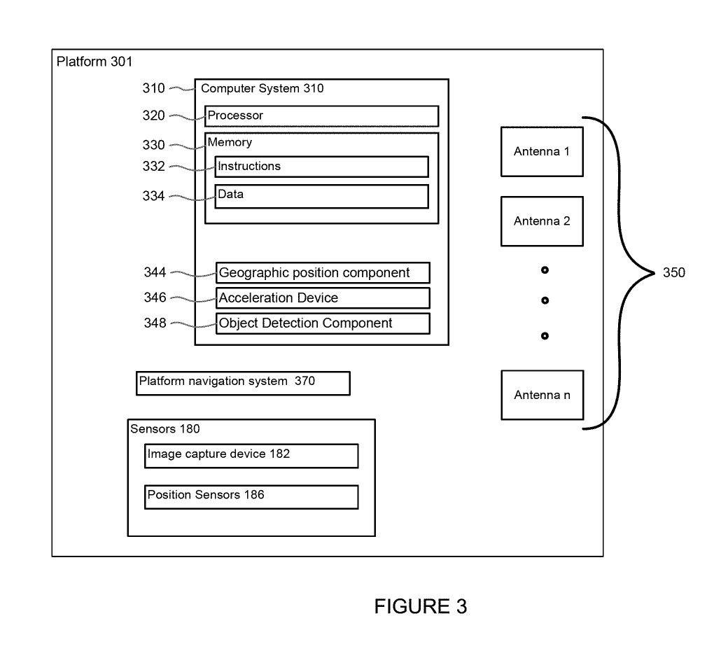

FIG. 3 is a block diagram illustrating an example platform 300, including various components. The platform may have one or more computers, such as computer 310 containing a processor 320, memory 330 and other components typically present in general purpose computers.

The memory 330 stores information accessible by processor 320, including instructions 332 and data 334 that may be executed or otherwise used by the processor 320. The memory 330 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 332 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 334 may be retrieved, stored or modified by processor 320 in accordance with the instructions 332. For instance, although the system and method is not limited by any particular data structure, the data may be stored in computer registers, in a relational database as a table having a plurality of different fields and records, XML documents or flat files. The data may also be formatted in any computer-readable format. The data may comprise any information, such as numbers, descriptive text, proprietary codes, references to data stored in other areas of the same memory or different memories (including other network locations) or information that is used by a function to calculate the relevant data.

The processor 320 may be any conventional processor, such as processors from Intel Corporation or Advanced Micro Devices. Alternatively, the processor may be a dedicated device such as an ASIC. Although FIG. 3 functionally illustrates the processor, memory, and other elements of computer 310 as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor or computer will be understood to include references to a collection of processors or computers or memories that may or may not operate in parallel.

Computer 310 may include all of the components normally used in connection with a computer such as a central processing unit (CPU), graphics processing unit (GPU), memory (e.g., RAM and internal hard drives) storing data 334 and instructions such as a web browser, an electronic display (e.g., a monitor having a screen, a small LCD touch-screen or any other electrical device that is operable to display information), and user input (e.g., a keyboard, touch-screen and/or microphone).

Computer 310 may also include a geographic position component 344 to determine the geographic location of the platform 301. For example, computer 310 may include a GPS receiver to determine the platform's latitude, longitude and/or altitude position. Other location systems such as laser-based localization systems, inertial-aided GPS, or camera-based localization may also be used.

Computer 310 may also include other features, such as an accelerometer, gyroscope or other acceleration device 346 to determine the direction in which the device is oriented. By way of example only, the acceleration device may determine its pitch, yaw or roll (or changes thereto) relative to the direction of gravity or a plane perpendicular thereto. In that regard, it will be understood that a computer's provision of location and orientation data as set forth herein may be provided automatically to the user, other computers of the network, or both.

Computer 310 may also include an object detection component 348 to detect and identify objects, such as other platforms, birds, power lines, utility poles, or other obstructions. The detection system may include lasers, sonar, radar, cameras or any other such detection methods. In use, computer 310 may use this information to instruct the navigation system 370 to update a position of the platform 301. Alternatively or additionally, for example, this information may be used to instruct one or more of antennas 350 to transmit or receive on a specified channel.

Computer 310 may send and receive information from the various systems of platform 301, for example the navigation 370 system in order to control the movement, speed, etc. of platform 301. In some examples, such information may be received at the computer from another entity, such as a wireless ground controller. For example, computer 310 may be capable of communicating with a remote server or other computer (not shown) configured similarly to computer 310, with a processor, memory, instructions, and data. The remote server or other computer may receive position information and/or other information from the sensors 380 and/or antennas 350. Based on the received information, along with information received from one or more other platforms neighboring the platform 301, the remote server may determine an updated configuration for one or more of the antennas 350. Accordingly, the remote server may send instructions to the one or more antennas. In other examples, such information may be determined by the computer 310 based on information detected by sensors 380, antennas 350, or other components of the platform 301.

It will be understood that although various systems and computer 310 are shown within platform 301, these elements may be external to platform 301 or physically separated.

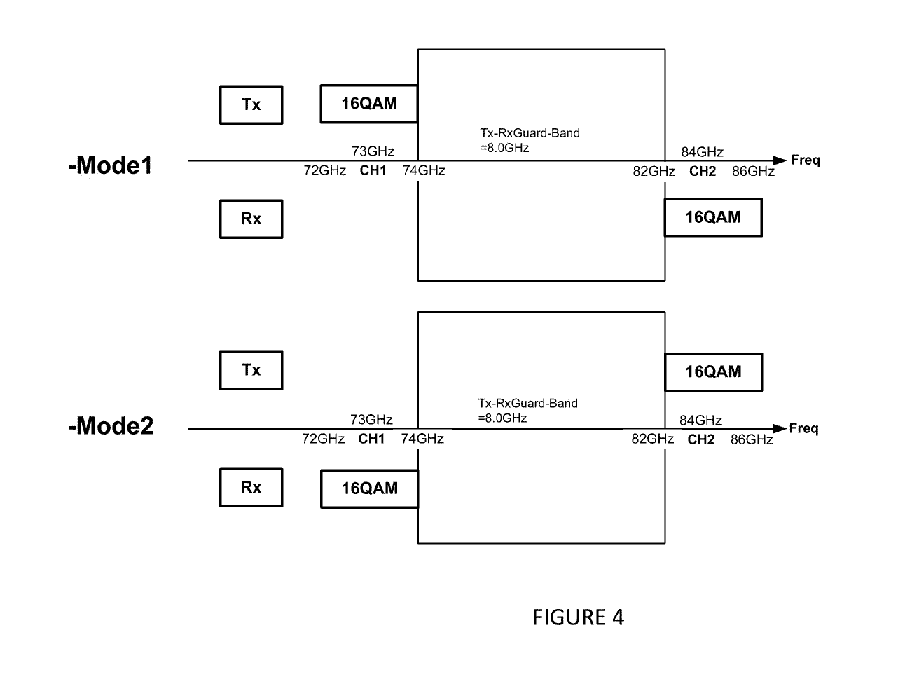

FIG. 4 illustrates an example of different modes of operation of inter-platform links (IPLs) on the platform. For example, two or more RF channels are fed into two or more IPL antenna apertures independently. Each antenna may be operable in at least two different modes. In the first mode, shown as Mode 1, an antenna transmits on a first channel (CH1) centering at a first frequency. In this example, CH1 centers at 73 GHz. In Mode 1, the antenna also receives on a second channel (CH2) centering at a second frequency. In this example, CH2 centers at 84 GHz. The second mode, Mode 2, is similar to Mode 1, but the antenna receives on CH1 centering at the first frequency and transmits on CH2 centering at the second frequency.

A width of a spectrum assigned for each channel CH1, CH2 may vary. For example, as shown in FIG. 4, CH1 is 2 GHz wide, extending from 72 GHz-74 GHz, and CH2 is 4 GHz wide, extending from 82 GHz-86 GHz. However, each channel may be predetermined to be wider or narrower, and CH1 may have the same width as CH2 or a different width. Moreover, while CH1 and CH2 are shown as centering at particular frequencies, it should be understood that these are merely examples and that such frequencies may be changed. Further, while the spectrum assigned in FIG. 4 is in the millimeter wave E-band, the spectrum may be extended to other radio frequencies, such as in the microwave and millimeter wave spectrums.

A guard band exists between the first frequency and the second frequency. The guard band is sufficiently wide to prevent channel leakage between CH1 and CH2. In the example shown, the guard band is 8 GHz wide, but it should be understood that the width of the guard band may be varied.

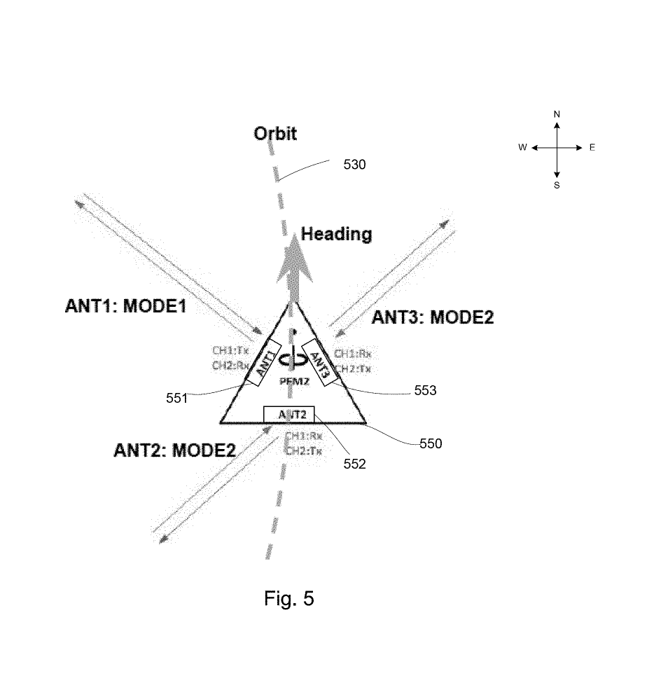

FIG. 5 illustrates a given platform 550 having a plurality of antennas 551-553, each operating in one of the first mode and the second mode. The platform 550 is shown as traveling in an orbit 530, heading north. The modes may be predetermined for designated areas. For example, a region northwest of particular geographic coordinates may be designated for Mode 1, while regions northeast or southwest of the given geographic coordinates may be designated for Mode 2. The first antenna 551 is used to establish links that extend in the northwest region, and therefore the antenna 551 operates in Mode 1. The second and third antennas 552, 553, however, are used to establish links in the northeast and southwest directions, and therefore operate in Mode 2.

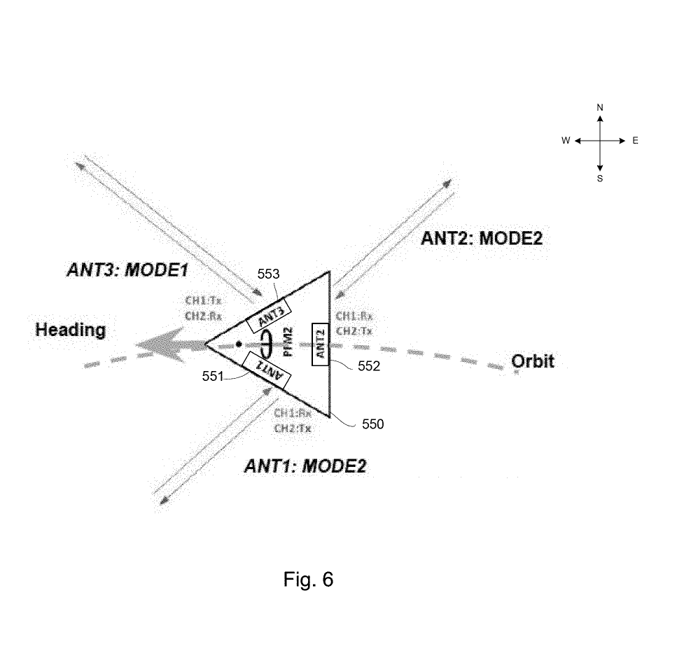

FIG. 6 illustrates the platform 500 having a different heading. For example, the platform 500 may be at a different point in the orbit 530, or may be in the same geographic position as in FIG. 5 but traveling in a different orbit. As such, positioning of each respective antenna 551-553 is changed. As a result, whereas the first antenna 551 was previously operating in Mode 1, it switches to Mode 2 in FIG. 6. Conversely, while the third antenna 553 was previously operating in Mode 2 in FIG. 5, it switches to Mode 1 in FIG. 6.

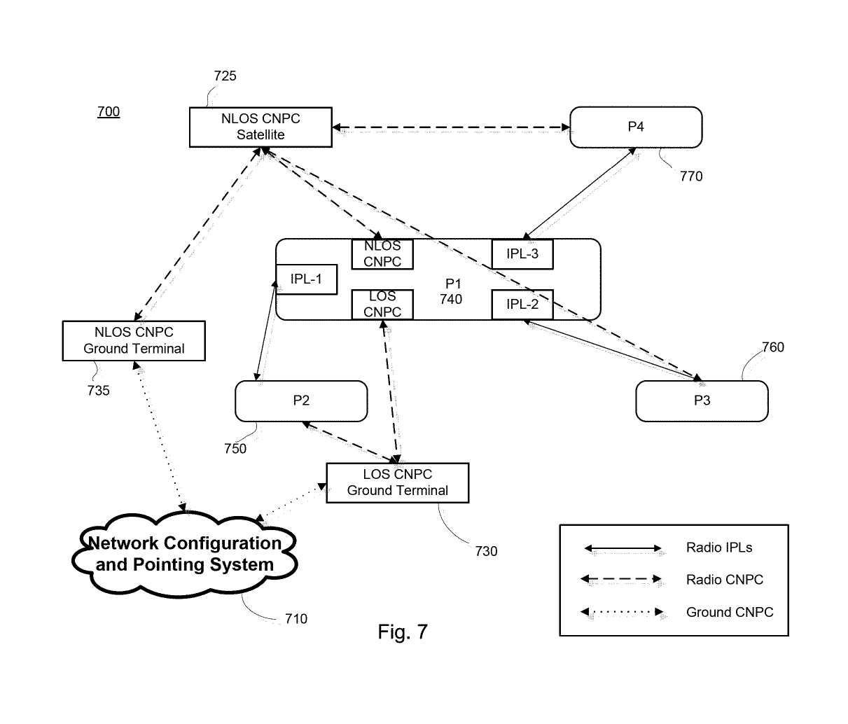

FIG. 7 illustrates an example system 700 for reconfiguring IPLs. In this example, platform 740 may include one or more antennas for establishing IPLs, line-of-sight (LOS) control-and-non-payload communication (CNPC) links, and non-line of sight (NLOS) CNPC links. The LOS CNPC link may communicatively couple the platform 740 to a network configuration and pointing system 710, for example, through an LOS CNPC ground terminal 730. For example, the LOS CNPC link between the platform 740 and the ground terminal 730 may be a low-data-rate air-ground radio link, while the link between the LOS CNPC ground terminal 730 and the network configuration and pointing system 710 includes terrestrial fiber or copper cable. The NLOS CNPC link may also communicatively couple the platform 740 to the network configuration and pointing system 710, for example, through an NLOS CNPC satellite 725 and an NLOS CNPC ground terminal 735.

Moreover, the platform 740 may include one or more processors and sensors (as discussed above in connection with FIG. 3), which provide geographical, heading, and positioning information, such as information indicating a direction in which each antenna points. Such information may be sent by the platform 740 to a network and configuration pointing system 710, for example through the LOS or NLOS CPNC links.

In response to sending the information to the network configuration and pointing system 710, the platform 740 may receive from the system 710 radio/network configuration commands and/or pointing commands. For example, the network configuration and pointing system 710 may include one or more processors, which use the information received from the platform 740 to run trajectory and pointing predictions and software-defined network proxy. Based on these predictions and determinations, the system 710 may send instructions to the platform 740 through the NLOS or LOS CNPC links.

In response to receiving commands from the network configuration and pointing system 710, the one or more processors on the platform 740 send low-level hardware commands to set radio channel assignments for the antenna apertures servicing the IPLs. The one or more platform processors may also set other network configurations for each IPL, such as data rate, etc. Moreover, the one or more platform processors may cause physical changes to the antenna, such as adjusting a gimbal to cause the antenna to point in a different direction.

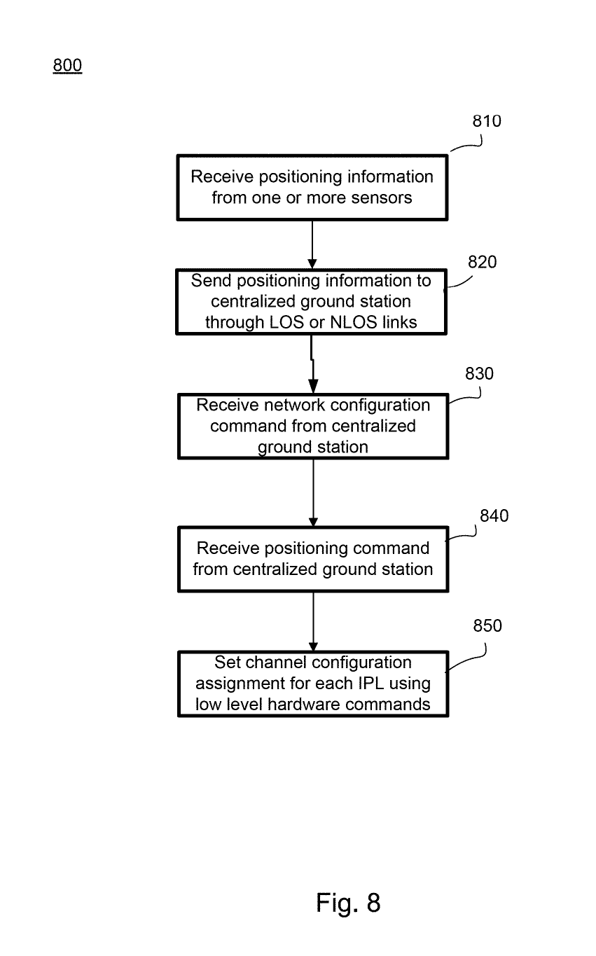

FIG. 8 illustrates an example method 800 of controlling IPLs for a given platform using out-of-band communication channels, such as discussed above in connection with FIG. 7. In block 810, position information is received from one or more sensors. For example, gyroscopes, accelerometers, radar, sonar, or any other type of sensor may be placed on a moving platform and used to detect information regarding the platform, such as position information including geographic coordinates, heading, orientation, and distance relative to other objects.

In block 820, the received information is provided to a centralized ground station, for example, through LOS or NLOS links. The centralized ground station may use the received information to determine an update or adjustment for the antennas on the platform. For example, the centralized ground station may determine that one or more of the antennas should operate in a different mode, point in a different direction, etc. The centralized ground station may also communicate with other platforms, and receive similar position information from such platforms. The various platforms may or may not be in direct communication with each other. Accordingly, in some examples, the determinations made by the centralized ground station for a first platform may be based in part on information received from a second platform.

In block 830, the given platform receives network configuration commands from the centralized ground station. For example, the commands may indicate that a particular antenna should operate in a particular mode, at a particular frequency, etc.

In block 840, the given platform receives positioning commands from the centralized ground station. For example, the commands may cause the platform to move to a specified geographic coordinate, to change orientation (yaw, pitch, or roll), to change heading, or to otherwise adjust its position.

In block 850, the platform may set channel configuration assignments for each IPL using low-level hardware commands. For example, one or more processors on the given platform, in response to receiving the network configuration commands, may adjust operation of the antennas.

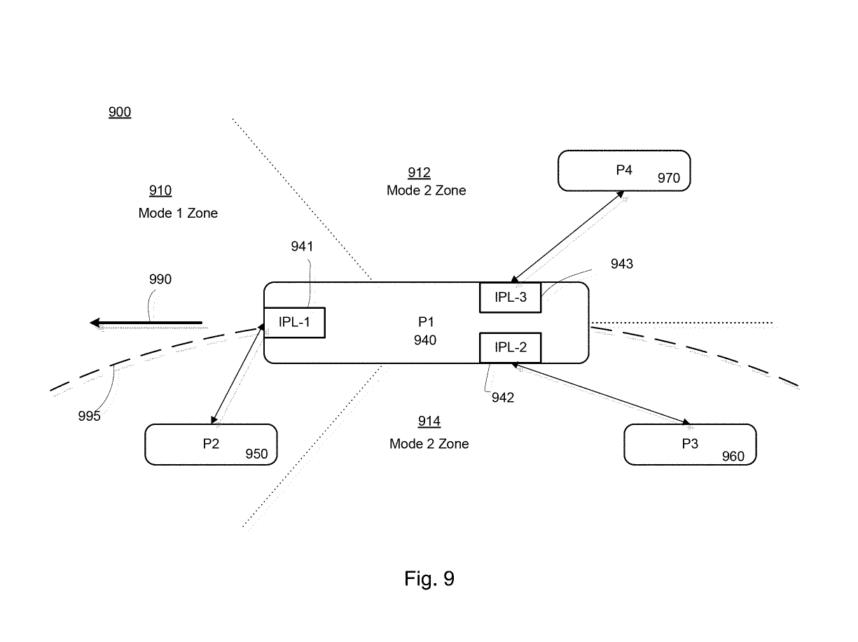

FIG. 9 illustrates another example system 900, wherein channel assignments for IPLs are set based on geometry and heading of the platform. As shown, a first platform 940 communicates with a plurality of other platforms 950-970 using IPLs 941-943, respectively. The platform 940 in heading in a particular direction 990 in an orbit 995. Further, a plurality of zones 910-914 are pre-defined, as indicated by dotted lines. The zones 910-914 may be defined relative to geographic areas or points in space, relative to the orbit 995 which may also be predefined, or relative to other conditions. Information relating to these predefined zones may be stored, for example, in a memory onboard the platform 940.

In this example, one or more processors onboard the platform 940 may receive information from one or more sensors on the platform 940. Such information may include, for example, geometry, heading, antenna pointing status, etc. The one or more processors may determine channel assignments for each of the IPLs 941-943, for example, based on the received information from the sensors and the predefined zone information. For example, the one or more processors may determine that the antennas pointed toward the platform 950 for communicating over the first IPL 941 are in the first zone 910. The one or more processors may further recognize that the first zone 910 is designated a Mode 1 zone. Accordingly, the one or more processors on the platform 940 may locally configured the IPL 941 to operate in Mode 1. According to some examples, the one or more processors may continue to receive such information and make such determinations periodically, and locally update the channel assignments when necessitated by movement of the antennas into a different predefined zone.

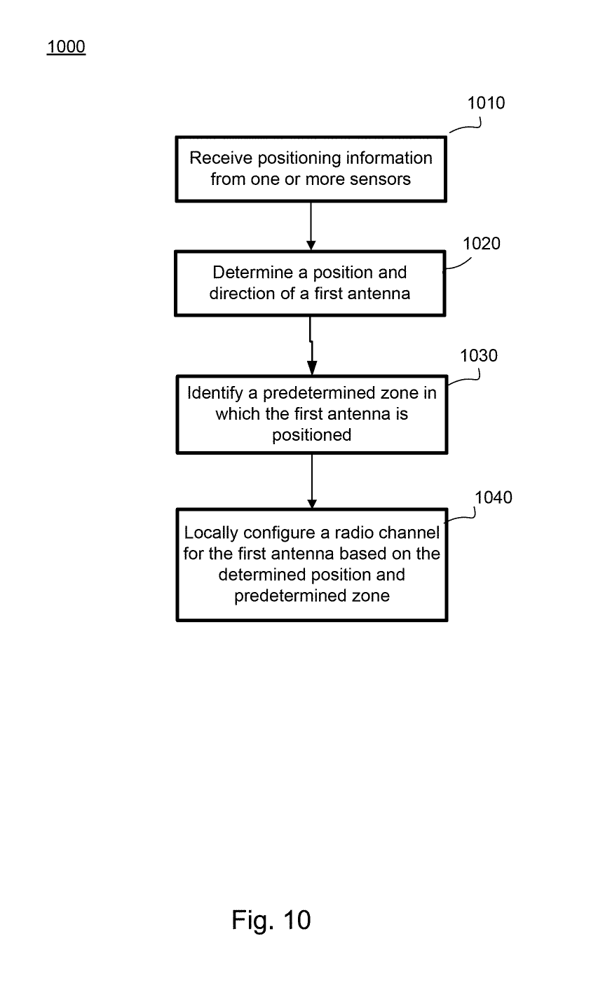

FIG. 10 illustrates an example method 1000 for configuring IPLs based on preset channel assignments. In block 1010, positioning information is received from one or more sensors. In block 1020, a position and direction of a first antenna may be determined based on the received position information. In block 1030, a predefined zone in which the first antenna is positioned is identified. In block 1040, a radio channel for the first antenna is locally configured based on the determined position and the identified zone.

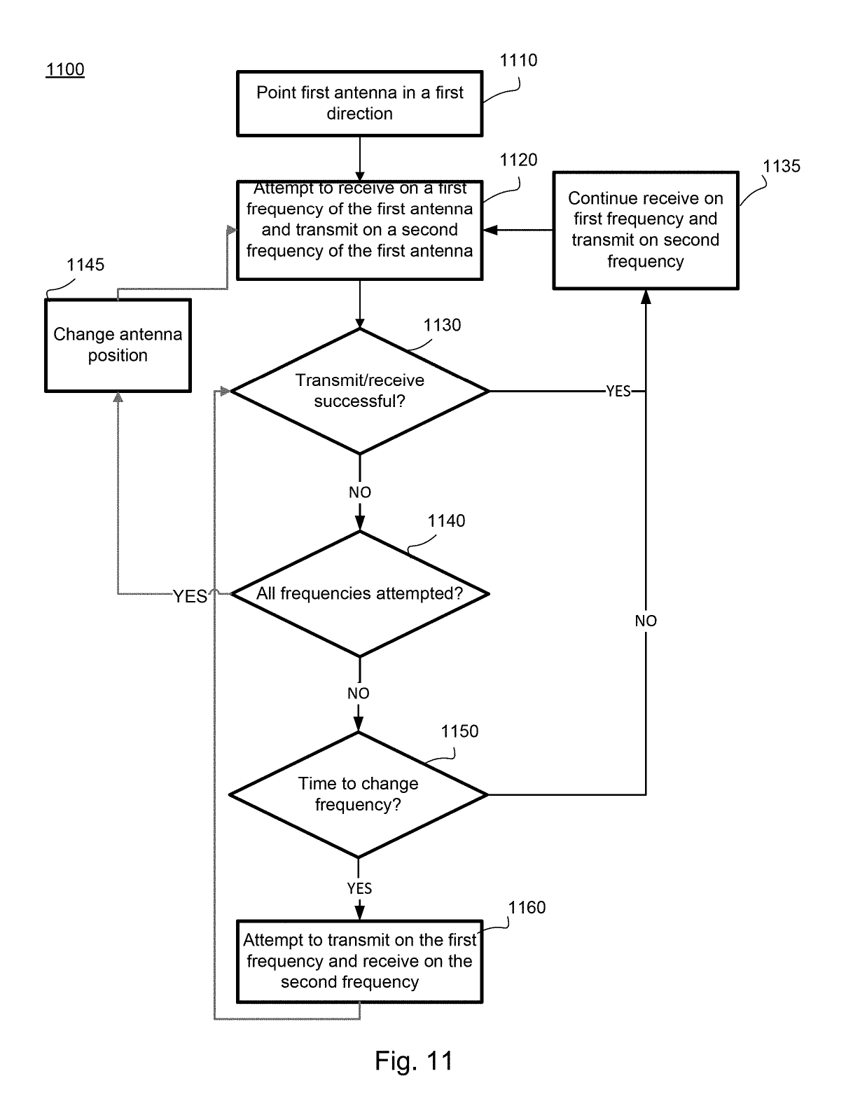

According to other examples, a configuration for the antennas on the platform may be determined using a coordinated search. For example, FIG. 11 illustrates a method 1100 for configuring antennas. In block 1110, a first antenna on a first platform is pointed in a first direction. The first antenna may be controlled by a processor on the first platform, or by a remote processor.

In block 1120, the first antenna attempts to receive on a first frequency and transmit on a second frequency. In block 1130, it may be determined whether the attempts are successful. If the first antenna is successfully transmitting and receiving, it may continue to do so. In some examples, the process may return to block 1120 so that successful configuration can be periodically or continually monitored. Alternatively or additionally, the process may be repeated for second and further antennas on the platform.

If the transmit/receive attempts of the first antenna are determined not to be successful in block 1130, it may be determined in block 1140 whether all possible frequencies have been attempted. For example, the first antenna may not have yet attempted to transmit on the first frequency and receive on the second frequency. If all frequencies have been attempted, a position of the first antenna may be changed in block 1145. For example, the first antenna may be moved to point to a second direction, and another attempt is made as the process returns to block 1120. In other examples, the first antenna may be programmed to attempt each frequency a predetermined number of times before changing positions.

If all frequencies have not yet been attempted, the method may proceed to block 1150 where it is determined whether it is time to change the frequencies for transmitting/receiving. For example, the platform may use a time reference, such as GPS time, to synchronize its changes in frequency and/or position. By way of example only, the configuration of the first antenna may be changed only on time boundaries, such as one second boundaries. According to other examples, the antennas may perform frequency hopping. For example, each antenna may have a designated frequency hopping type. Antennas designated as a first type may change frequency after first intervals, such as every one second, while antennas designated as a second type may change frequency after second intervals different from the first interval, such as every two seconds.

If it is time to change frequencies, in block 1150 the antenna may change frequencies. Accordingly, the first antenna will attempt to transmit on the first frequency and receive on the second frequency. The method may then return to block 1130 to determine whether such attempts were successful.

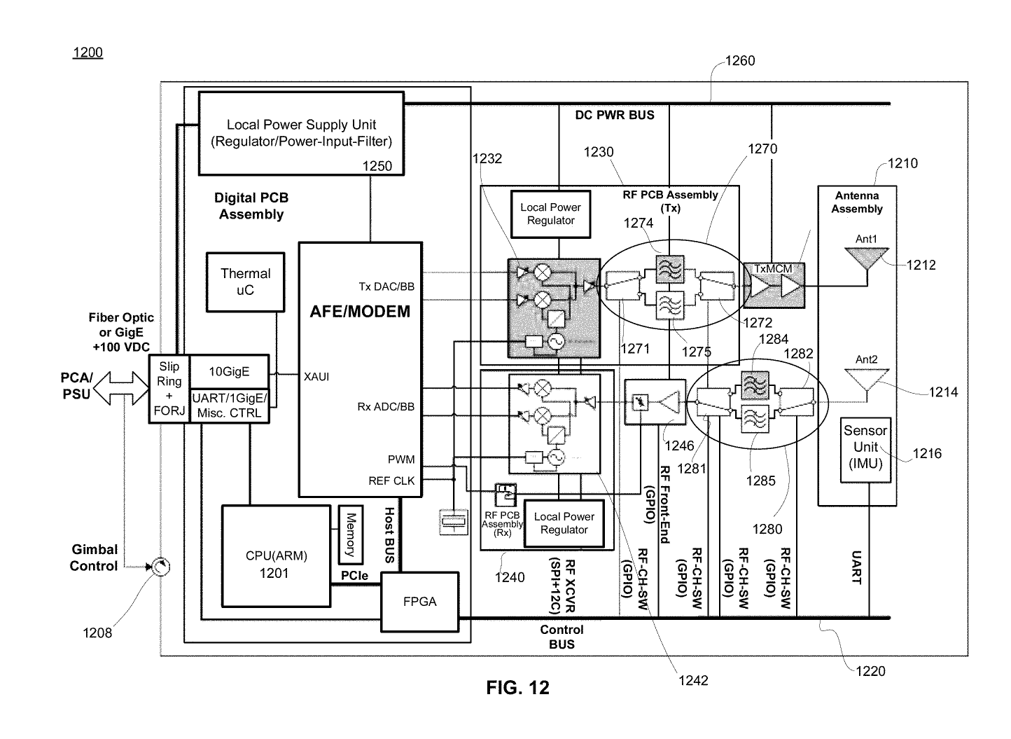

FIG. 12 is a circuit diagram providing a detailed illustration of an example bidirectional antenna 1200. An antenna assembly 1210 includes a first aperture 1212 and a second aperture 1214. The first aperture 1212 is coupled to an RF printed circuit board (PCB) transmitter assembly 1230. The second aperture 1214 is coupled to an RF PCB receiver assembly 1240. The antenna assembly 1210 may also include a sensor unit 1216, which may be used for determining position information related to the antenna 1200. The sensor unit 1216, transmitter assembly 1230, receiver assembly 1240, and other elements are controlled by one or more processors, such as CPU 1201, which is coupled to the elements through control bus 1220. These elements are powered by a local power supply unit 1250, which is coupled to the elements through power bus 1260.

The antenna apertures 1212, 1214 may be, for example, electromagnetic radiators, which are in planar-form, low-volume, low-mass, and high-efficiency. The size and mass of each antenna aperture is significantly smaller than traditional antenna apertures. For example, the dual antenna apertures 1212, 1214 may be the same size as a single traditional parabolic antenna. Also, each antenna aperture is able to achieve high-directional gain to a desired beam-angle, which intrinsically increases spatial isolation between the two antenna apertures 1212, 1214. Although the dual antenna system is designed to provide wide-frequency-bandwidth for covering both Tx and Rx bands, they are also highly isolated with each other in spatial domain, such as above 65 dB. Accordingly, additional frequency-channel-switching and frequency-channel-multiplexing components do not need to be implemented. The antenna apertures 1212, 1214 are physically space apart from one another, allowing for control of the transmitting/receiving isolation with each other, which increases the system flexibility. For example, the first apertures 1212 may be positioned approximately 1 cm from the second aperture 1214, although greater distances are possible and may further reduce interference. In other examples, the physical spacing of the apertures may be less than 1 cm, such as 0.5 cm. In other examples, it may be greater, such as 2 cm or more. It should be understood that the distances between the apertures may be varied while still maintaining spatial isolation. The dual-antenna-aperture could also be expanded to triple or more antenna apertures, as explained in further detail below, and thus may easily support throughput-capacities upgrades.

According to some examples, digital and/or analog predistortion techniques may be implemented to control transmit adjacent channel power leakage (ACPL). While the antenna modules, amplifier modules, and frequency-conversion modules may be wide-band enough, for example, to cover entire mmWave bands, the operation and/or tuning frequencies may be limited to cover only a sub-section of the mmWave bands. Accordingly, both the transmitting and receiving channels are assigned within these maximum operation sub-bands. To reduce adjacent channel leakage, besides the intrinsic spatial isolation from the multiple antenna system, digital and/or analog predistortion may be implemented, and may thereby bring down spectrum-regrowth, and self Tx/Rx interference.

The PCB transmitter assembly 1230 includes a transmitter 1232. Similarly, the PCB receiver assembly 1240 includes a receiver 1242. Each of the transmitter 1232 and receiver 1242 include a phase locked loop (PLL) and voltage controlled oscillator (VCO). These elements may be used to change a configuration of the antenna. For example, the PLL and VCO of the transmitter 1232 may control whether the first aperture 1212 transmits at a first frequency or a second frequency. Similarly, the PLL and VCO of receiver 1242 may control whether the second aperture 1214 receives at the first channel or the second channel.

In the example of FIG. 12, frequency selection sub-modules 1270, 1280 and amplifiers 1236, 1246 are coupled between the antenna apertures 1212, 1214 and the PCB assemblies 1230, 1240. The transmitting amplifier 1236 may be a high power amplifier, while the receiving amplifier 1246 is a low noise amplifier. The submodules 1270, 1280 include dual solid-state single-pole-double-throw (SPDT) switches 1271, 1272, 1281, 1282, as well as compact planar or surface mount technology (SMT) frequency filters 1274, 1275, 1284, 1285. Accordingly, the SPDT may be used to select between the frequency filters to complete an electrical connection between the transmitter or receiver assemblies and the apertures 1212, 1214. For example, for the transmitting aperture 1212, both of the SPDT switches 1271, 1272 may be switched to either first frequency filter 1274 to transmit on a first channel, or second frequency filter 1275 to transmit on a second frequency channel. These frequency-selection sub-modules 1270, 1280 provide leakage filtering and interference noise rejection for the receiving aperture 1214, and provide pre-power-amplifier spectrum regrowth suppression for the transmitting aperture 1212.

The sensor unit 1216 may include any of a number of different types of sensors, such as accelerometers, odometers, GPS, radar, gyroscopes, light sensors, or any other sensors. The sensor unit 1216 may thus detect a pointing direction of the antenna apertures 1212, 1214, a position, relational distance to other antennas, etc. and provide such information to the CPU 1201.

The CPU 1201 may be any type of processor, such as a microprocessor. As discussed above, it may be configured to receive information from the sensor unit 1216, determine an operation mode for the apertures 1212, 1214, and provide instructions to the components. For example, the CPU may determine which channel the receiving aperture 1214 should use, and may send low level hardware instructions causing the switches 1281, 1282 in frequency selection submodule 1280 to select the frequency filter 1284, 1285 that would result in the aperture 1214 operating on the determined channel.

The antenna 1200 also include a active front end (AFE) modem 1205. The modem 1205 may be a generic modem, for example, used to communicate over a network. Accordingly, the modem 1205 may receive information over the network to be further transmitted by the aperture 1212. In other examples the modem 1205 may receive information used to control operation of the transmitter assembly 1230, such as changing a transmission channel.

The antenna 1200 also includes a gimbal control 1208, which may be used to adjust a pointing position of the apertures 1212, 1214. The gimbal control 1208 may include, for example, a motor. The gimbal control 1208 may be

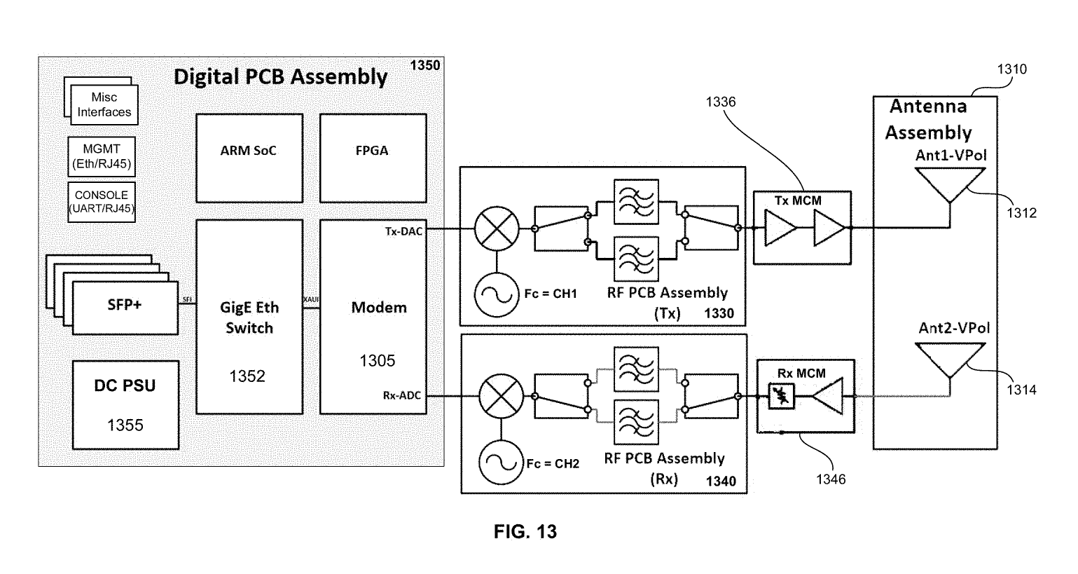

Other examples of bidirectional antennas are also provided. For example, FIG. 13 provides a more simplified illustration of another example antenna 1300. The antenna 1300 also includes an antenna assembly 1310, including two antenna apertures: a transmitting aperture 1312 and a receiving aperture 1314. The transmitting aperture 1312 is coupled to an amplifier 1336, such as a wide-band transmitting amplifier, which is further coupled to a transmission assembly 1330 including a frequency selection module. The receiving aperture is coupled to a low noise receiving amplifier 1346, which is further coupled to receiver assembly 1340 including a frequency selection module. The transmitter assembly 1330 and receiver assembly 1340 are further coupled to a digital process control block assembly 1350, including modem 1305, power supply 1355, Ethernet switch 1352, etc.

The amplifiers 1336, 1346 should be wide-band enough to support two or more adjacent frequency channels. For example, the antenna 1300 may operate at mmWave bands (carrier frequency 30˜300 GHz). The operation frequency bands of the system are sub-divided for two sub-bands, with center frequencies F1, F2, and can be expanded to multiple sub-bands, with center frequencies F3, F4, . . . Fn. The amplifiers 1336, 1346 are designed to support wide-frequency-bandwidth that includes F1, F2. Regardless of the carrier frequencies of the sub-band of the following upconverter and downconverter, the amplifier modules and the antenna modules are able to support the operation frequencies.

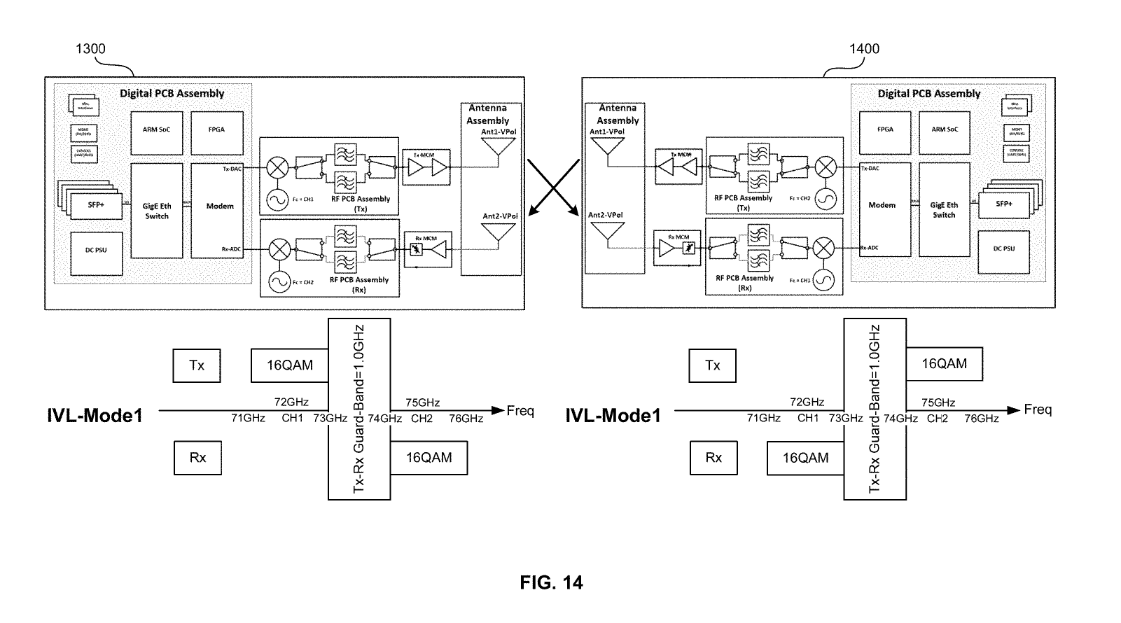

FIG. 14 illustrates an example of communication between two bidirectional antennas 1300, 1400. Each of these antennas 1300, 1400 is shown as having the same structure, which is discussed above in connection with FIG. 13. In this example, the antenna 1300 is operating in a first mode, Mode 1, while the antenna 1400 is operating in a second mode, Mode 2. As such, the antenna 1300 transmits on a first channel, and the antenna 1400 receives on the first channel. Similarly, the antenna 1400 transmits on a second channel, different from the first channel, and the antenna 1300 receives on the second channel. Accordingly, each antenna 1300, 1400 may transmit to and receive from the other antenna at a same time. Matching by one of the antennas, such as the antenna 1400, to the other may be performed using any of the techniques described above in connection with FIGS. 7-11.

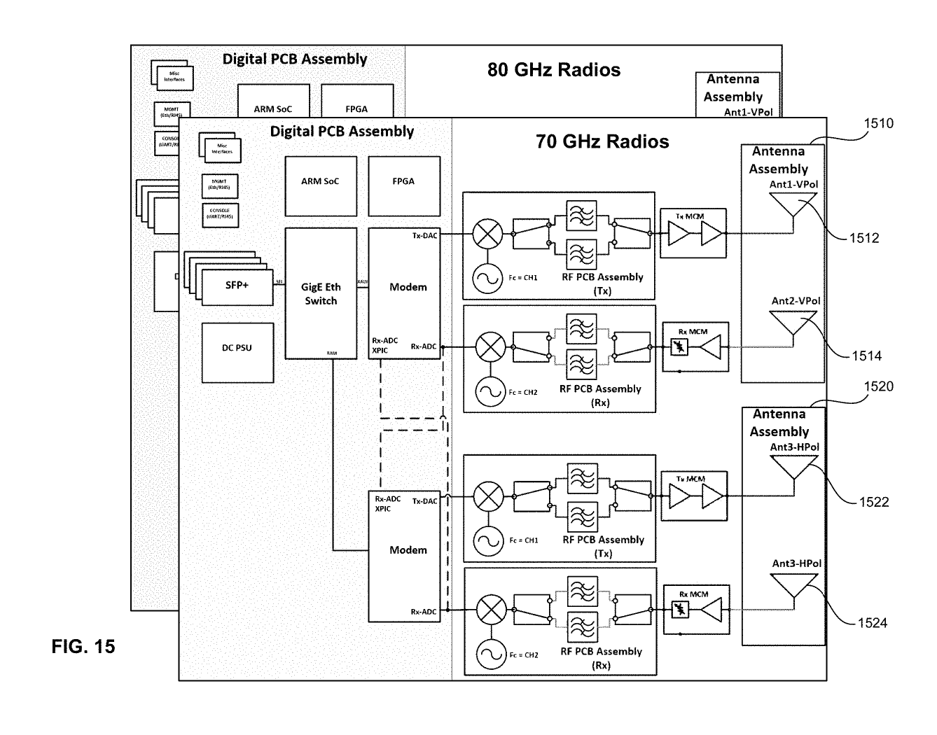

As mentioned above, in some examples, the number of antenna apertures may be increased to provide expanded capabilities for the antennas. For example, as shown in FIG. 15, two antenna assemblies 1510, 1520 are provided, each assembly having dual apertures 1512, 1514, 1522, 1524. Similarly, the modem, transmitter assembly, receiver assembly, and amplifiers are doubled as compared to the example 1300 of FIG. 13. Accordingly, each of the apertures 1512, 1514, 1522, 1524 may operate on a different channel Each of the apertures may be physically spaced to provide isolation from leakage and reduce noise. Moreover, each of the apertures may point in a different direction. The expanded capability antenna may communicate with multiple other platforms simultaneously.

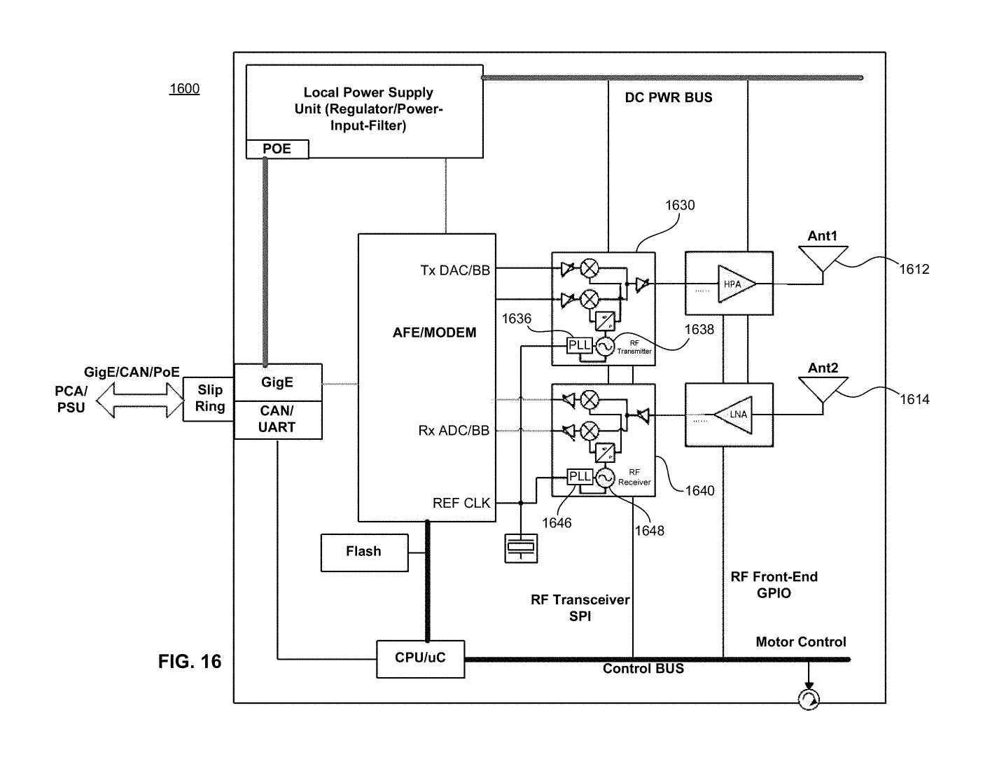

FIG. 16 provides another example antenna 1600. In this example, the antenna 1600 does not include a frequency selection sub-module. Rather, channel reconfiguration for transmitter 1630 is performed by phase locked loop (PLL) 1636 and voltage controlled oscillator (VCO) 1638. Similarly, channel reconfiguration for receiver 1640 is performed by PLL 1646 and VCO 1648.

In this example, apertures 1612, 1614 may cover an entire frequency band between, for example, 71 GHz-76 GHz. By way of example only, the antenna may transmit at a first channel which may be defined between 71-73 GHz. Moreover, the antenna may receive at a second channel, which may be defined between 74-76 GHz. According to this example, a guard band between the first channel and the second channel may be only approximately 1 GHz. The antenna may also be operable in a second mode, wherein it transmits at the second channel and receives at the first channel.

While a number of example implementations have been described, it should be understood that these examples are merely illustrative and not exclusive. Numerous modifications may be made to the examples and that other arrangements may be devised without departing from the spirit and scope of the disclosure.

1. A multidirectional antenna, comprising:
a first antenna aperture;
a frequency-tunable wide-band upconverter coupled to the first aperture, the upconverter adapted to transmit millimeter wave radio frequency signals;
a second antenna aperture physically spaced from the first aperture;
a frequency-tunable wide-band downconverter coupled to the second antenna, the downconverter adapted to receive millimeter wave radio frequency signals;
wherein the upconverter is configured to transmit on one of a first frequency channel or a second frequency channel;
wherein the downconverter is configured to receive, concurrently with the transmission by the upconverter, on the second frequency channel if the upconverter is transmitting on the first frequency channel, or on the first frequency if the upconverter is transmitting on the second frequency channel.

2. The multidirectional antenna of claim 1, further comprising one or more processors, the one or more processors configured to determine a frequency band being used by the upconverter at a given time, and adjust an operating frequency band of the downconverter in response.

3. The multidirectional antenna of claim 1, further comprising one or more processors, the one or more processors configured to:
receive position information related to the first antenna;
determine which frequency channel to use for transmitting and which frequency channel to use for receiving based on the received position information; and
adjust an operation mode of the first antenna based on the determination.

4. The multidirectional antenna of claim 1, wherein each of the upconverter and the downconverter comprise a phase locked loop and a voltage controlled oscillator used to select one of the first and the second frequency channel.

5. The bidirectional antenna of claim 1, further comprising:
a first frequency selection submodule coupled between the upconverter and the first aperture;
a second frequency selection submodule coupled between the downconverter and the second aperture;
each frequency selection submodule comprising a first frequency filter coupled in parallel with a second frequency filter between two single pole double throw switches.

6. The multidirectional antenna of claim 1, further comprising:
a third antenna aperture coupled to a second upconverter; and
a fourth antenna aperture coupled to a second downconverter;
wherein the third antenna aperture and the fourth antenna aperture are configured to operate on different channels than the first aperture and second aperture.

7. The multidirectional antenna of claim 1, further comprising a motor adapted to adjust a pointing direction of the first aperture and the second aperture.

8. A mobile platform, comprising:
one or more bidirectional antennas, each bidirectional antenna comprising:
a first antenna aperture;
a second antenna aperture;
a transmitter coupled to each of the first aperture and the second aperture, the transmitter adapted to select between different frequency channels;
a receiver coupled to each of the first aperture and the second aperture, the receiver adapter to select between different frequency channels; and
one or more processors in communication with the one or more bidirectional antennas, the one or more processors programmed to configure the one or more bidirectional antennas, such that the transmitter transmits through one of the first aperture or the second aperture on a first frequency channel, and the receiver receives through one of the first aperture or the second aperture on a second frequency channel, the first aperture and the second aperture operating simultaneously in different modes.

9. The mobile platform of claim 8, further comprising one or more sensors configured to detect information related to a position of the mobile platform and communicate the detected information to the one or more processors.

10. The mobile platform of claim 9, wherein the one or more processors configures the one or more bidirectional antennas based on the position information received from the one or more sensors.

11. The mobile platform of claim 9, wherein the one or more sensors comprise at least one of an accelerometer, a gyroscope, or a global positioning system.

12. The mobile platform of claim 8, further comprising a motor for adjusting a pointing direction of the one or more bidirectional antennas.

13. The mobile platform of claim 8, wherein the platform is one of an unmanned aerial vehicle, a satellite, a balloon, or a buoy.

14. A method for millimeter wave radio frequency communication, comprising:
receiving, at one or more processors, position information from one or more sensors;
determining, with the one or more processors, a position and direction of a first antenna on a first mobile platform based on the received information;
determining, with the one or more processors, an operation mode for the first antenna based on the determined position and direction, the operation mode indicating a frequency channel on which to transmit signals and a frequency channel on which to simultaneously receive signals; and
providing instructions, with the one or more processors, to the first antenna, causing the first antenna to operate in the determined operation mode.

15. The method of claim 14, further comprising:
identifying, with the one or more processors, a predetermined zone in which the mobile platform is positioned;
wherein determining the operation mode is further based on the identified predetermined zone.

16. The method of claim 15, wherein the one or more processors reside on the first mobile platform, and providing instructions to the first antenna comprises sending low level hardware instructions to locally configure the first antenna.

17. The method of claim 14, further comprising:
receiving position information from a second antenna on a second mobile platform;
determining, with the one or more processors, relative positions between the first antenna and the second antenna; and
determining an operation mode of the second antenna;
wherein determining the operation mode for the first antenna is further based on the operation mode of the second antenna.

18. The method of claim 17, wherein the one or more processors are stationed in a centralized ground control unit.

19. The method of claim 14, wherein determining the operation mode for the first antenna is performed in response to determining that a current position and direction of the first antenna has changed from a previous position and direction.
